(19) United States
(12) Patent Application Publication
(10) Pub. No.: US 2026/0042398 A1
(43) Pub. Date: Feb. 12, 2026

(54) RETRACTABLE STEP

(71) Applicant: Textron Inc., Providence, RI (US)

(72) Inventor: Paul Edward Morgan, Appling, GA (US)

(73) Assignee: Textron Inc., Providence, RI (US)

(21) Appl. No.: 18/798,462

(22) Filed: Aug. 8, 2024

(51) Int. Cl. B60R 3/02

(52) U.S. Cl. CPC B60R 3/02

(57) ABSTRACT

A golf vehicle includes a vehicle frame, a floorboard coupled to the vehicle frame, and a step assembly coupled to the floorboard. The step assembly includes a step platform that is repositionable relative to the floorboard between a stowed configuration and a deployed configuration. The step platform is at a first height when in the stowed configuration. The step platform is at a second height, lower than the first height, when in the deployed configuration.

### BACKGROUND

Golf vehicles are used to transport personnel and equipment between different areas. By way of example, a golf vehicle may transport golfers and equipment (e.g., golf bags, golf clubs, etc.) around a golf course (e.g., along a cart path, between different holes, etc.). It may be desirable to improve the ease of ingress or egress of operators and/or passengers of the golf vehicle, while maintaining a desired ground clearance.

### SUMMARY

One embodiment relates to a golf vehicle. The golf vehicle includes a vehicle frame, a floorboard coupled to the vehicle frame, and a step assembly coupled to the floorboard. The step assembly includes a step platform that is repositionable relative to the floorboard between a stowed configuration and a deployed configuration. The step platform is at a first height when in the stowed configuration. The step platform is at a second height, lower than the first height, when in the deployed configuration.

Another embodiment relates to a golf vehicle. The golf vehicle includes a vehicle frame, a rear-facing seat assembly coupled to the vehicle frame, a floorboard coupled to at least one of the vehicle frame or he rear-facing sea assembly, the floorboard positioned beneath and extending longitudinally rearward of the rear-facing seat assembly, and a step assembly coupled to the floorboard. The step assembly includes a step platform that is repositionable relative to the floorboard between a stowed configuration and a deployed configuration. The step platform is positioned beneath the floorboard at a first height when in the stowed configuration. The step platform is positioned away from the floorboard at a second height, lower than the first height, when in the deployed configuration.

Still another embodiment relates to a rear-facing seat assembly for a golf vehicle. The rear-facing seat assembly includes a seat body, a floorboard positioned underneath the seat body and extending longitudinally rearward thereof, and a step assembly coupled to the floorboard. The step assembly includes a step platform that is repositionable relative to the floorboard between a stowed configuration and a deployed configuration. The step platform is at a first height when in the stowed configuration. The step platform is at a second height, lower than the first height, when in the deployed configuration

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a rear perspective view showing a portion of a vehicle including a step assembly shown in a stowed configuration, according to an exemplary embodiment.

FIG. 4 is a rear perspective view showing a portion of a vehicle including a step assembly shown in a deployed configuration, according to an exemplary embodiment.

FIG. 5 is a rear perspective view showing a portion of a vehicle including a step assembly shown in a stowed configuration, according to an exemplary embodiment.

FIG. 6 is a rear perspective view showing a portion of a vehicle including a step assembly shown in a deployed configuration, according to an exemplary embodiment.

FIG. 7 is a rear perspective view showing a rear seat assembly including a step assembly shown in a stowed configuration, according to an exemplary embodiment.

FIG. 8 is a rear perspective view showing a rear seat assembly including a step assembly shown in a deployed configuration, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

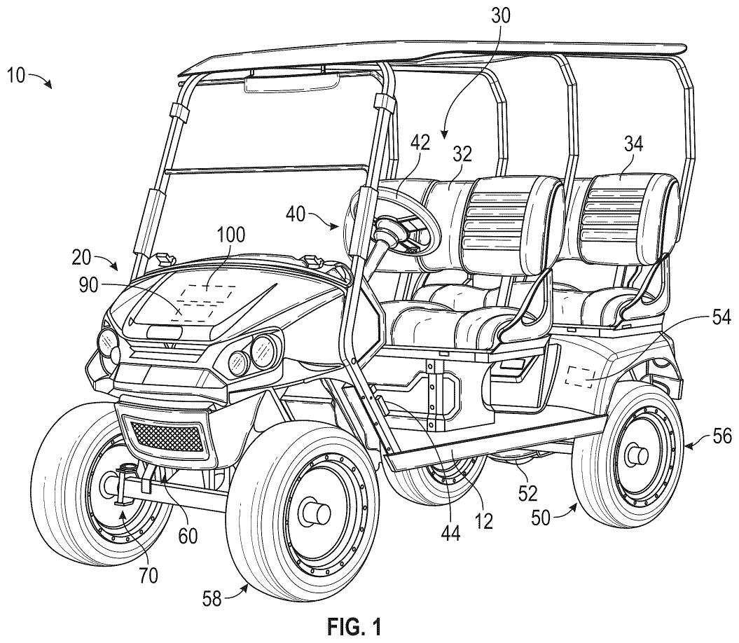

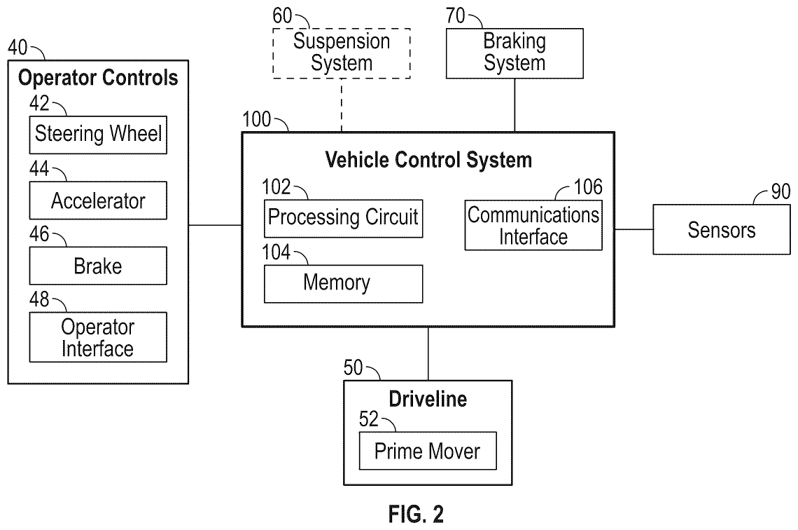

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein.

According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Vehicle Structure

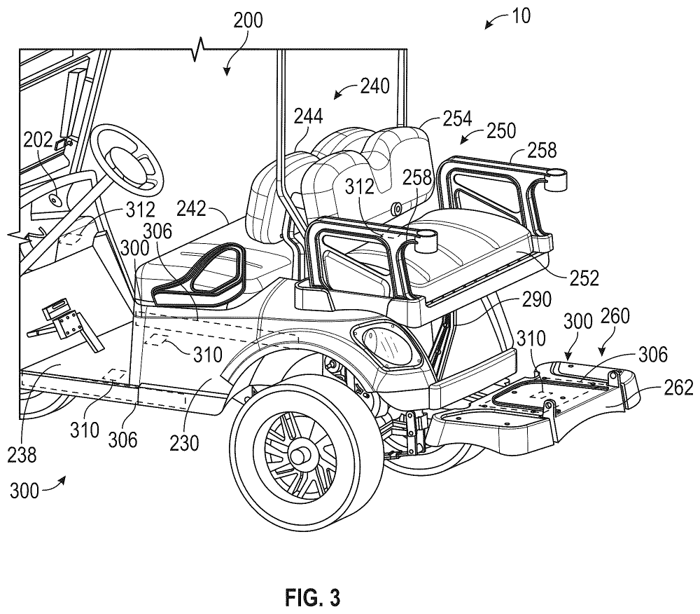

Referring to FIGS. 3-6, the vehicle 10 is shown according to various exemplary embodiments. The vehicle 10 of FIGS. 3-6 may be substantially similar to the vehicle 10 of FIG. 1 except as otherwise specified herein. In some embodiments, the vehicle 10 is configured as a golf vehicle.

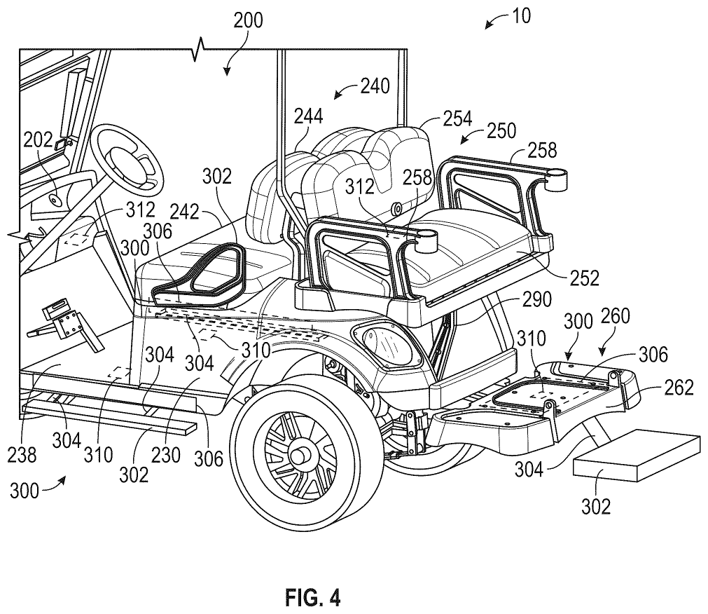

As shown in FIGS. 3 and 4, the vehicle 10 includes a cabin portion, shown as cab 200.

The cab 200 is coupled to the frame 12. The cab 200 includes at least a portion of the occupant seating area 30, such as the front row seating 32. The operator controls 40 are positioned within the cab 200. The operator controls 40 include a vehicle power switch, shown as ignition switch 202. The ignition switch 202 may be a keyed switch, requiring a key to operate the ignition switch 202. In some embodiments, the key may be inserted into a portion of the ignition switch 202 to enable operate the ignition switch 202. In other embodiments, the key may establish a wirelessly communication with the ignition switch 202 to enable operation of the ignition switch 202. When the ignition switch 202 is turned on, the ignition switch 202 facilitates enabling the prime mover 52 (e.g., by starting combustion of fuel and/or by enabling the flow of electrical energy to the prime mover 52). When the ignition switch 202 is turned off, the ignition switch 202 facilitates disabling the prime mover 52 (e.g., by ceasing combustion of fuel and/or by substantially preventing the flow of electrical energy to the prime mover 52).

As shown in FIGS. 3 and 4, the vehicle 10 includes the front row seating 32 and the rear row seating 34. The front row seating 32 is facing forward, and the rear row seating 34 is facing rearward. The front row seating 32 is provided as part of a first seat assembly, shown as front-facing seat assembly 240 in FIGS. 3 and 4. The rear row seating 34 is provided as part of a second seat assembly, shown as rear-facing seat assembly 250 in FIGS. 3, 4, 7, and 8. As shown in FIGS. 3 and 4, the front-facing seat assembly 240 is coupled to the frame 12 and extends laterally across the body 20, from a right side of the body 20 (e.g., a first lateral side) to a left side of the body 20 (e.g., a second lateral side). Accordingly, the front-facing seat assembly 240 may provide at least two seats (e.g., for an operator or driver and one or more passengers).

As shown in FIGS. 3 and 4, the front-facing seat assembly 240 includes a first seat portion, shown as seat body 242 (e.g., a first seat body, a forward-facing seat body, a seat bottom, etc.), and a second seat portion, shown as backrest 244 (e.g., a first backrest, forward-facing backrest, etc.). The seat body 242 extends substantially horizontally and supports the bottom of the occupant. The backrest 244 extends substantially vertically and supports the back of the occupant.

As shown in FIGS. 3 and 4, the rear-facing seat assembly 250 is coupled to the frame 12 and extends laterally across the body 20, from a right side of the body 20 (e.g., a first lateral side) to a left side of the body 20 (e.g., a second lateral side). Accordingly, the rear-facing seat assembly 250 may provide at least two seats (e.g., for one or more passengers). As shown in FIGS. 3, 4, 7, and 8, the rear-facing seat assembly 250 includes a first seat portion, shown as seat body 252 (e.g., a second seat body, a rear-facing seat body, a seat bottom, etc.), a second seat portion, shown as backrest 254 (e.g., a second backrest, a rear-facing backrest, etc.), and one or more arm rests, shown as arm rests 258 (e.g., a first arm rest and a second arm rest). The seat body 252 extends substantially horizontally and supports the bottom of the occupant. The backrest 254 extends substantially vertically and supports the back of the occupant. The arm rest 258 is coupled to the seat body 252 and is positioned at a lateral side (e.g., a first lateral side and/or a second lateral side) of the seat body 252.

As shown in FIGS. 3 and 4, the body 20 includes an under-seat portion, shown as seat pedestal 230, that extends directly beneath and supports the seat body 242 and seat body 252. The seat pedestal 230 has a pair of lateral sides that extend along the left and right sides of the body 20, respectively, and a front side that extends between the lateral sides.

As shown in FIGS. 3 and 4, the vehicle 10 includes a first horizontal portion, shown as floorboard 238 (e.g., a first floorboard, a forward floorboard, etc.), that extends substantially horizontally, forward of the seat pedestal 230 and toward a front end of the vehicle 10. The floorboard 238 is positioned beneath the front-facing seat assembly 240 (e.g., underneath the seat body 242). In some embodiments, the floorboard 238 is coupled to the frame 12. The floorboard 238 may support the feet of an occupant as the occupant steps into the vehicle 10 (e.g., to enter or exit the front-facing seat assembly 240).

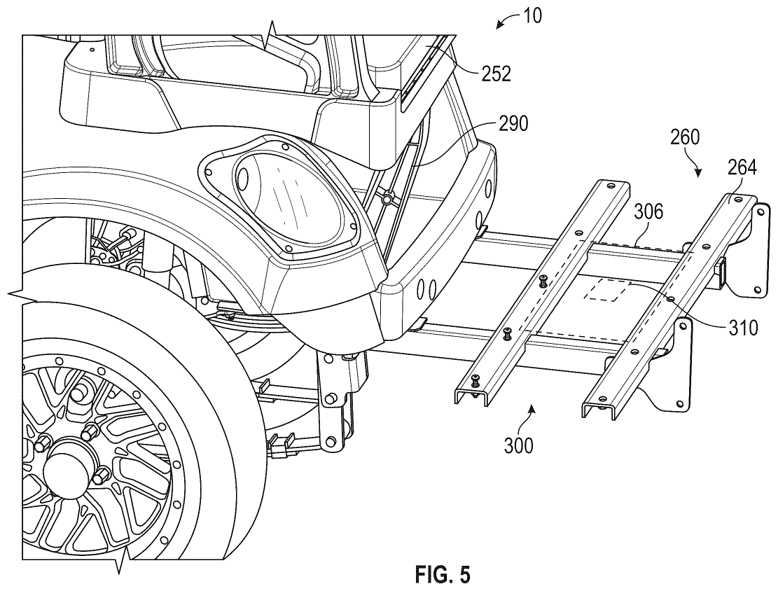

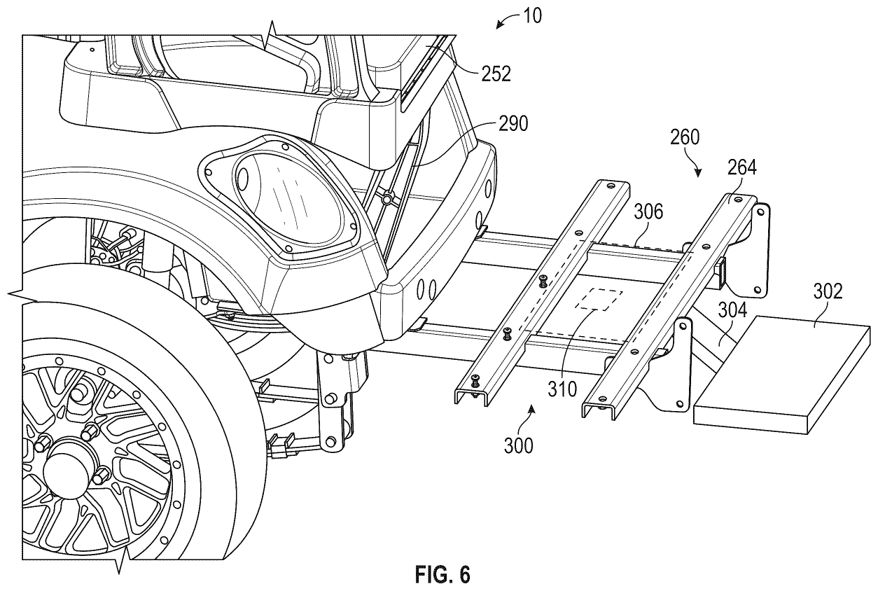

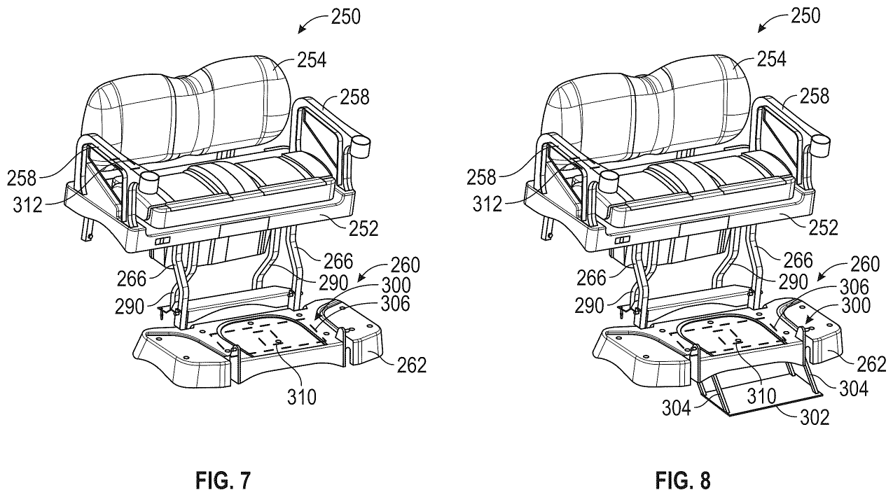

As shown in FIGS. 3-8, the vehicle 10 includes a second horizontal portion, shown as floorboard 260 (e.g., a second floorboard, a rear floorboard, etc.), that extends substantially horizontally and longitudinally rearward of the rear-facing seat assembly 250 and a rear end of the vehicle 10. The floorboard 260 is positioned beneath the rear-facing seat assembly 250 (e.g., underneath the seat body 252). The floorboard 260 may support the feet of an occupant as the occupant steps into the vehicle 10 (e.g., to enter or exit the rear-facing seat assembly 250). As shown in FIGS. 3, 4, 7, and 8, the floorboard 260 includes a first portion, shown as floorboard body 262. The floorboard body 262 may support the feet of an occupant while entering or exiting the rear-facing seat assembly 250 and/or while occupying the rear-facing seat assembly 250. As shown in FIGS. 5 and 6, the floorboard 260 includes a second portion, shown as floorboard frame 264. According to an exemplary embodiment, the floorboard frame 264 is positioned underneath the floorboard body 262 to at least partially support the floorboard body 262. In some embodiments (see, e.g., FIGS. 5 and 6), the floorboard frame 264 is coupled to the frame 12 such that the vehicle frame 12 at least partially supports the floorboard 260. In some embodiments (see, e.g., FIGS. 7 and 8), the floorboard frame 264 is additionally or alternatively coupled to the seat body 252. As shown in FIGS. 7 and 8, the floorboard 260 includes one or more first support members, shown as floorboard supports 266, extending between an underside of the seat body 252 and the floorboard frame 262 such that the seat body 252 at least partially supports the floorboard 260.

As shown in FIGS. 3-8, the vehicle 10 includes one or more second support members, shown as rear seat support 290. As shown in FIGS. 3-8, the rear seat support 290 is coupled to seat body 252 of the rear-facing seat assembly 250. According to an exemplary embodiment, the rear seat support 290 extends between the vehicle frame 12 and the rear-facing seat assembly 250 such that the rear seat support 290 at least partially supports the rear-facing seat assembly 250.

### Step Assembly

As shown in FIGS. 3-8, the vehicle 10 includes a step mechanism (e.g., a retractable step, a deployable step, a deployable side runner, etc.), shown as step assembly 300. As described herein, the step assembly 300 may be provided in a plurality of different configurations. For example, as shown in FIGS. 3 and 4, the vehicle 10 includes a first configuration of the step assembly 300. As shown in FIGS. 3 and 4, the step assembly 300 includes a first step assembly proximate a first lateral side of the cab 200 and a second step assembly 300 proximate an opposing second lateral side of the cab 200 (e.g., underneath the floorboard 238). As shown in FIGS. 3-8, the vehicle 10 includes a second configuration of the step assembly 300 positioned proximate a rear end of the vehicle 10 (e.g., underneath the floorboard 260). In some embodiments, the vehicle 10 includes multiple step assemblies 300, such as one or more step assemblies in the first configuration and a step assembly in the second configuration.

As shown in FIGS. 4, 6, and 8, the step assembly 300 includes a deployable portion, shown as step platform 302. According to an exemplary embodiment, the step platform 302 is repositionable between a stowed configuration and a deployed configuration. As shown in FIGS. 3 and 4 the step platform 302 is repositionable relative to the floorboard 238. As shown in FIGS. 5-8 the step platform 302 repositionable relative to the floorboard 260. The step platform 302 is at a first height when in the stowed configuration. The step platform 302 is at a second height, lower than the first height, when in the deployed configuration. Advantageously, when the step platform 302 is in the stowed configuration, the step platform 302 does not substantially interfere with a ground clearance of the vehicle 10. The ground clearance of the vehicle 10 refers to the vertical distance between the underside of a portion of the vehicle 10, such as the frame 12, and the ground. According to an exemplary embodiment, when the step platform 302 is in the stowed configuration, the step platform 302 is located substantially at or above the underside of the frame 12, such that the step platform 302 does not interfere with the ground clearance.

As shown in FIG. 4, the step assembly 300 includes one or more deployment members, shown as arm 304. The arm 304 pivotably couples the step platform to the floorboard 238. The arm 304 facilitates repositioning the step platform 302 between the stowed configuration and the deployed configuration. In some embodiments, step assembly 300 includes multiple arms 304 (e.g., a first arm, a second arm, etc.). In these embodiments, the arms 304 are spaced from each other (e.g., a second arm is spaced from a first arm). Each arm 304 pivotably couples the step platform 302 to the floorboard 238 and facilitates repositioning the step platform 302 between the stowed configuration and the deployed configuration.

As shown in FIGS. 3 and 4, the step assembly 300 includes a housing 306 coupled to an underside or sidewall of the floorboard 238. As shown in FIG. 4 the arm 304 extends between the housing 306 and the step platform 302.

As shown in FIGS. 3 and 4, the step assembly 300 is positioned proximate a lateral side of the floorboard 238. As shown in FIG. 3, the step platform 302 is positioned beneath the floorboard 238 when the step platform is in the stowed configuration. As shown in FIG. 4, the step platform 302 is positioned laterally away or outward from the floorboard 238 when the step platform 302 is in the deployed configuration.

As shown in FIGS. 3 and 4, the step assembly 300 is a first step assembly, and the lateral side is a first lateral side of the floorboard 238. The vehicle 10 includes a second step assembly 300 positioned proximate a second lateral side of floorboard 238, opposite the first lateral side of the floorboard 238.

As shown in FIGS. 6 and 8, the step assembly 300 includes at least one arm 304. The arm 304 pivotably couples the step platform 302 to the floorboard 260 (e.g., the floorboard frame 264). The arm 304 facilitates repositioning the step platform 302 between the stowed configuration and the deployed configuration. In some embodiments, step assembly 300 includes multiple arms 304 (e.g., a first arm, a second arm, a third arm, a fourth arm, etc.). In these embodiments, the arms 304 are spaced from each other (e.g., a second arm is spaced from a first arm, coupled to each corner of the step platform 302, etc.). Each arm 304 pivotably couples the step platform 302 to the floorboard 260 and facilitates repositioning the step platform 302 between the stowed configuration and the deployed configuration.

As shown in FIGS. 5-8, the housing 306 is coupled to an underside of the floorboard 260. As shown in FIGS. 6 and 8, the arm 304 extends between the housing 306 and the step platform 302.

As shown in FIGS. 5-8, the step assembly 300 is positioned at least partially underneath the floorboard 260. As shown in FIGS. 5 and 7, the step platform 302 is positioned beneath the floorboard 260 when the step platform 302 is in the stowed configuration. As shown in FIGS. 6 and 8, the step platform 302 is positioned longitudinally rearward from the floorboard 260 when the step platform 302 is in the deployed configuration. In other embodiments, the step platform 302 is positioned laterally away from the floorboard 260 when the step platform 302 is in the deployed configuration.

As shown in FIGS. 3-8, the step assembly 300 includes an actuator (e.g., an electric motor, a servo motor, a stepper motor, a pneumatic cylinder, a hydraulic cylinder, etc.) shown as step actuator 310. The step actuator 310 is configured to selectively reposition the step platform 302 between the stowed configuration and the deployed configuration. In some embodiments, the step assembly 300 does not include the step actuator 310 (e.g., the step assembly in manually operated).

In some embodiments, when the vehicle 10 includes the ignition switch 202, the actuator 310 is configured to reposition the step platform 302 based on the ignition switch 202. In some embodiments, the actuator 310 is configured to reposition the step platform 302 from the stowed configuration to the deployed configuration in response to the ignition switch being turned off. In some embodiments, the actuator 310 is additionally or alternatively configured to reposition the step platform 302 from the deployed configuration to the stowed configuration in response to the ignition switch 202 being turned on.

As shown in FIGS. 3 and 4, the vehicle 10 includes a user interface (e.g., a button, a switch, a touch display, etc.), shown as user interface 312. As shown in FIGS. 7 and 8, the rear-facing seat assembly 250 additionally or alternatively includes the user interface 312. In any of the embodiments shown, the user interface 312 is configured to facilitate manually activating the actuator 310 to reposition the step platform 302. In some embodiments, the user interface 312 is configured to activate the actuator 310 to reposition the step platform 302 from the stowed configuration to the deployed configuration. In some embodiments, the user interface 312 is configured to activate the actuator 310 to reposition the step platform 302 from the deployed configuration to the stowed configuration. As shown in FIGS. 3 and 4, the user interface 312 is positioned within the cab 200. As shown in FIGS. 3, 4, 7, and 8, the user interface 312 is positioned on at least one of the arm rests 258. In other embodiments, the user interface 312 is otherwise positioned. In some embodiments, the user interface 312 is a lever or other manual actuator that can be manipulated by an occupant of the vehicle 10 to stow or deploy the step assembly from the front seat assembly 240 and/or the rear seat assembly 250 (e.g., without the actuator 310).

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) as shown in the various exemplary embodiments is illustrative only. Additionally, any element disclosed in one embodiment may be incorporated or utilized with any other embodiment disclosed herein.

1. A golf vehicle comprising:
a vehicle frame;
a floorboard coupled to the vehicle frame; and
a step assembly coupled to the floorboard, the step assembly including a step platform repositionable relative to the floorboard between a stowed configuration and a deployed configuration;
wherein the step platform is at a first height when in the stowed configuration; and
wherein the step platform is at a second height, lower than the first height, when in the deployed configuration.

2. The golf vehicle of claim 1, wherein the step assembly includes an arm pivotably coupling the step platform to the floorboard, the arm facilitating repositioning the step platform between the stowed configuration and the deployed configuration.

3. The golf vehicle of claim 2, wherein:
the arm is a first arm; and
the step assembly includes a second arm spaced from the first arm, the second arm pivotably coupling the step platform to the floorboard, and the second arm facilitating repositioning the step platform between the stowed configuration and the deployed configuration.

4. The golf vehicle of claim 2, wherein the step assembly includes a housing coupled to an underside of the floorboard, and wherein the arm extends between the housing and the step platform.

5. The golf vehicle of claim 1, further comprising a front-facing seat assembly coupled to the vehicle frame, wherein:
the floorboard is positioned beneath the front-facing seat assembly; and
the step assembly is positioned proximate a lateral side of the floorboard.

6. The golf vehicle of claim 5, wherein the step platform is positioned beneath the floorboard when the step platform is in the stowed configuration, and wherein the step platform is positioned laterally away from the floorboard when the step platform is in the deployed configuration.

7. The golf vehicle of claim 5, wherein the step assembly is a first step assembly, and wherein the lateral side of the floorboard is a first lateral side of the floorboard, further comprising a second step assembly positioned proximate a second lateral side of floorboard, opposite the first lateral side of the floorboard.

8. The golf vehicle of claim 1, further comprising a rear-facing seat assembly coupled to the vehicle frame, wherein:
the floorboard is positioned beneath the rear-facing seat assembly; and
the step assembly is positioned at least partially underneath the floorboard.

9. The golf vehicle of claim 8, wherein the step platform is positioned beneath the floorboard when the step platform is in the stowed configuration, and wherein the step platform is positioned longitudinally away from the floorboard when the step platform is in the deployed configuration.

10. The golf vehicle of claim 8, wherein the floorboard extends longitudinally rearward of the rear-facing seat assembly.

11. The golf vehicle of claim 1, wherein the step assembly includes an actuator configured to selectively reposition the step platform between the stowed configuration and the deployed configuration.

12. The golf vehicle of claim 11, further comprising an ignition switch, wherein the actuator is configured to reposition the step platform at least one of (a) from the stowed configuration to the deployed configuration in response to the ignition switch being turned off or (b) from the deployed configuration to the stowed configuration in response to the ignition switch being turned on.

13. The golf vehicle of claim 11, further comprising a user interface configured to facilitate manually activating the actuator to reposition the step platform at least one of (a) from the stowed configuration to the deployed configuration or (b) from the deployed configuration to the stowed configuration.

14. The golf vehicle of claim 13, further comprising a seat assembly coupled to the vehicle frame, wherein the seat assembly has an arm rest, and wherein the user interface is positioned on the arm rest.

15. The golf vehicle of claim 1, further comprising:
a seat assembly coupled to the vehicle frame; and
a support extending between the vehicle frame and the seat assembly, the support at least partially supporting the seat assembly.

16. The golf vehicle of claim 1, further comprising:
a seat assembly coupled to the vehicle frame above the floorboard; and
a support extending between the seat assembly and the floorboard, the support at least partially supporting the floorboard.

17. A golf vehicle comprising:
a vehicle frame;
a rear-facing seat assembly coupled to the vehicle frame;
a floorboard coupled to at least one of the vehicle frame or the rear-facing seat assembly, the floorboard positioned beneath and extending longitudinally rearward of the rear-facing seat assembly; and
a step assembly coupled to the floorboard, the step assembly including a step platform repositionable relative to the floorboard between a stowed configuration and a deployed configuration;
wherein the step platform is positioned beneath the floorboard at a first height when in the stowed configuration; and
wherein the step platform is positioned away from the floorboard at a second height, lower than the first height, when in the deployed configuration.

18. The golf vehicle of claim 17, wherein the floorboard is a first floorboard, and wherein the step assembly is a first step assembly, further comprising:
a front-facing seat assembly coupled to the vehicle frame;
a second floorboard coupled to the vehicle frame and positioned beneath the front-facing seat assembly; and
a second step assembly coupled to the second floorboard and positioned proximate a lateral side of the second floorboard.

19. A rear-facing seat assembly for a golf vehicle, the rear-facing seat assembly comprising:
a seat body;
a floorboard positioned underneath the seat body and extending longitudinally rearward thereof; and
a step assembly coupled to the floorboard, the step assembly including a step platform repositionable relative to the floorboard between a stowed configuration and a deployed configuration;
wherein the step platform is at a first height when in the stowed configuration; and
wherein the step platform is at a second height, lower than the first height, when in the deployed configuration.

20. The rear-facing seat assembly of claim 19, wherein the step platform is positioned beneath the floorboard when the step platform is in the stowed configuration, and wherein the step platform is positioned longitudinally rearward from the floorboard when the step platform is in the deployed configuration.
